(19) United States
(12) Patent Application Publication
(10) Pub. No.: US 2018/0173631 A1
(43) Pub. Date: Jun. 21, 2018

(54) PREFETCH MECHANISMS WITH NON-EQUAL MAGNITUDE STRIDE

(71) Applicant: QUALCOMM Incorporated, San Diego, CA (US)

(72) Inventors: Thomas Andrew SARTORIUS, Raleigh, NC (US); James Norris DIEFFENDERFER, Apex, NC (US); Thomas Philip SPEIER, Wake Forest, NC (US); Michael Scott MCILVAINE, Raleigh, NC (US); Michael William MORROW, Wilkes Barre, PA (US)

(21) Appl. No.: 15/594,631

(22) Filed: May 14, 2017

Related U.S. Application Data
(60) Provisional application No. 62/437,659, filed on Dec. 21, 2016.

(51) Int. Cl. G06F 12/0862; G06F 17/30

(52) U.S. Cl. CPC G06F 12/0862; G06F 2212/6026; G06F 17/30495

(57) ABSTRACT

Systems and methods are directed to prefetch mechanisms involving non-equal magnitude stride values. A non-equal magnitude functional relationship between successive stride values, may be detected, wherein the stride values are based on distances between target addresses of successive load instructions. At least a next stride value for prefetching data, may be determined, wherein the next stride value is based on the non-equal magnitude functional relationship and a previous stride value. Data prefetch may be from at least one prefetch address calculated based on the next stride value and a previous target address. The non-equal magnitude functional relationship may include a logarithmic relationship corresponding to a binary search algorithm.

### CROSS-REFERENCE TO RELATED APPLICATIONS

The present application for patent claims the benefit of U.S. Provisional Application No. 62/437,659, entitled “PREFETCH MECHANISMS WITH NON-EQUAL MAGNITUDE STRIDE,” filed Dec. 21, 2016, assigned to the assignee hereof, and expressly incorporated herein by reference in its entirety.

### FIELD OF DISCLOSURE

Disclosed aspects are directed to processing systems. More specifically, exemplary aspects are directed to prefetch mechanisms, e.g., for a cache of a processing system, with a prefetch stride of non-equal magnitude, such as a logarithmic function.

### BACKGROUND

Processing systems may include mechanisms for speculatively fetching information such as data or instructions, in advance of a request or demand arising for the information. Such mechanisms are referred to as prefetch mechanisms and they serve the purpose of making information anticipated to have use in the near future readily available when the demand for the information arises. Prefetch mechanisms are known in the art for various memory structures including data caches (or D-caches), instruction caches (I-caches), memory management units (MMUs) or translation-lookaside buffers (TLBs) for storing virtual-to-physical address translations, etc.

Considering the example of a data cache, related prefetch mechanisms may pre-fill blocks of data from a backing storage location such as a main memory into the data cache in anticipation of the data being accessed in the near future by instructions such as load instructions. This way, when the load instructions are executed, the data blocks required by the load instructions will be available in the data cache and latency associated with a miss in the data cache may be avoided.

The prefetch mechanisms may implement several policies to determine which data blocks to prefetch from memory and when to prefetch these data blocks into the data cache, for example. In one example, a prefetch mechanism or a prefetch engine (e.g., implemented by a processor configured to access the data cache) may observe a sequence of data cache accesses by load instructions to determine whether there is a regular data pattern which is common to two or more of the observed load instructions. If consecutive load instructions are observed to have target addresses for data accesses, wherein the target addresses differ by a common or constant value, the constant value is set as a stride value. Some prefetch mechanisms may implement functionality to build a predetermined confidence level or confirmation of the stride value. If a stride value, e.g., of sufficient confidence is detected in this manner, then the prefetch mechanisms may commence prefetching data from target addresses calculated using the stride value and a prior or base target address of a load instruction of the sequence.

For an illustration of the above technique, if a sequence of load instructions to memory addresses 0, 100, 200, and 300 are observed by the prefetch mechanism, for example, the prefetch mechanism may detect that there is a stride value of 100 which is common between target addresses of successive load instructions of the sequence. The prefetch mechanism may then use the stride value, observe the last observed target address of 300 and prefetch a data block from address 300+100=400 into the data cache before the processor executes a load instruction which has a target address 400, with the assumption that the processor will execute a following load instruction which will follow the pattern created by the previous load instructions in the sequence. Relatedly, some prefetch mechanisms may prefetch data blocks from target addresses which are separated from the last observed target address by a multiple of the observed stride value to account for the time delay between the last load instruction of the sequence being observed and the time taken for prefetching the data blocks from memory. For example, starting to prefetch data blocks from target addresses such as 500 or 600, rather than 400, may account for the possibility that an intervening load instruction for accessing the target address 400 may have executed and already made a demand request before the data block from the target address 400 was prefetched.

Regardless of the multiple of the stride value which is prefetched, the known implementations of prefetch mechanisms are restricted to determining a stride value from observing a regularly repeated data pattern such as a constant stride value of 100 described in the above illustrative example. In other words, the conventional detection of stride values is based on an “equal magnitude compare,” which refers to determination of a sequence of three or more load instructions having the property wherein the stride value between the nth load and n+1th load has the same magnitude as the stride value between the n+1th load and the n+2nd load. If such a sequence is detected then the data prefetch will be initiated for a subsequent multiple of this equal magnitude stride value. It is noted that the notion of the equal magnitude stride value may be extended to both positive and negative values (i.e., the striding can be “forwards” or “backwards” in terms of the sequence of memory addresses).

However, there are striding behaviors which may be exhibited by programs and algorithms which may not be restricted to the equal magnitude stride values. Rather, some programs may have successive load instructions, for example, which target memory addresses which, although not set apart by an equal magnitude stride, may still exhibit some other well-defined relationship amongst them. For example, there may be functional relationship in the spaces between target addresses of successive load instructions which may be beneficial to exploit in determining which data blocks to prefetch. Conventional prefetch mechanisms which are limited to equal magnitude stride values are unable to harvest the benefit of prefetching data blocks from target addresses which have a functional relationship other than equal magnitude stride values.

### SUMMARY

Exemplary aspects of the invention are directed to systems and methods for prefetching based on non-equal magnitude stride values. A non-equal magnitude functional relationship between successive stride values, may be detected, wherein the stride values are based on distances between target addresses of successive load instructions. At least a next stride value for prefetching data, may be determined, wherein the next stride value is based on the non-equal magnitude functional relationship and a previous stride value. Data prefetch may be from at least one prefetch address calculated based on the next stride value and a previous target address. The non-equal magnitude functional relationship may include a logarithmic relationship corresponding to a binary search algorithm.

For example, an exemplary aspect is directed to a method of prefetching data, the method comprising: detecting a non-equal magnitude functional relationship between successive stride values, the stride values based on distances between target addresses of successive load instructions, and determining at least a next stride value for prefetching data, wherein the next stride value is based on the non-equal magnitude functional relationship and a previous stride value.

Another exemplary aspect is directed to an apparatus comprising a stride detection block configured to detect a non-equal magnitude functional relationship between successive stride values, the stride values based on distances between target addresses of successive load instructions executed by a processor, and a prefetch engine configured to determine at least a next stride value for prefetching data, wherein the next stride value is based on the non-equal magnitude functional relationship and a previous stride value.

Yet another exemplary aspect is directed to an apparatus comprising: means for detecting a non-equal magnitude functional relationship between successive stride values, the stride values based on distances between target addresses of successive load instructions, and means for determining at least a next stride value for prefetching data, wherein the next stride value is based on the non-equal magnitude functional relationship and a previous stride value.

Yet another exemplary aspect is directed to a non-transitory computer readable medium comprising code, which, when executed by a processor, causes the processor to perform operations for prefetching data, the non-transitory computer readable medium comprising: code for detecting a non-equal magnitude functional relationship between successive stride values, the stride values based on distances between target addresses of successive load instructions, and code for determining at least a next stride value for prefetching data, wherein the next stride value is based on the non-equal magnitude functional relationship and a previous stride value.

### BRIEF DESCRIPTION OF THE DRAWINGS

The accompanying drawings are presented to aid in the description of aspects of the invention and are provided solely for illustration of the aspects and not limitation thereof.

FIG. 1 depicts an exemplary block diagram of a processor system according to aspects of this disclosure.

FIG. 2 illustrates an example binary search method, according to aspects of this disclosure.

FIG. 3 depicts an exemplary prefetch method according to aspects of this disclosure.

FIG. 4 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In exemplary aspects of this disclosure, prefetch mechanisms are described for detecting stride values which may not be an equal magnitude stride, but satisfy other detectable and useful functional relationships which may be exploited for prefetching information. In this disclosure, a data cache will be described as one example of a storage medium to which exemplary prefetch mechanisms may be applied. However, it will be understood that the techniques described herein may be equally applicable to any other type of storage medium, such as an instruction cache or a TLB. Moreover, exemplary techniques may be applicable to any level of cache (e.g., level 1 or L1, level 2 or L2, level 3 or L3, etc.) as known in the art.

In one example, prefetch mechanisms based on a functional relationship such as a logarithmic relationship (or equivalently, an exponential relationship) between successive stride values, is disclosed in the following sections. Although not exhaustively described, exemplary techniques may be extended to other functional relationships between successive stride values which can result in non-equal magnitude stride values. Such other functional relationships can involve a geometric relationship or a fractional relationship (or equivalently, a multiple relationship). It will be understood that the non-equal magnitude stride values described herein are distinguished from conventional techniques mentioned above which use an equal magnitude stride value but may prefetch from a multiple of the equal magnitude stride value.

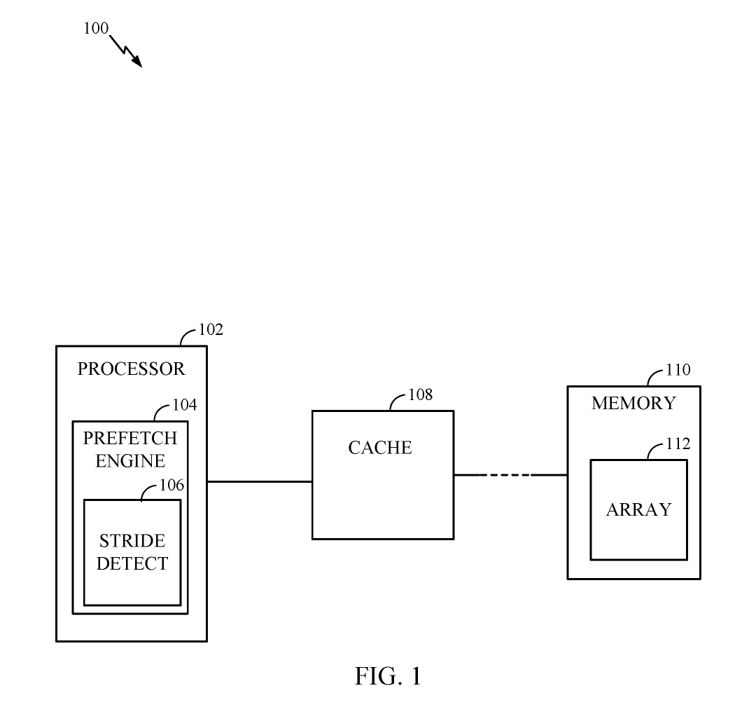

With reference now to FIG. 1, an example processing system 100 in which aspects of this disclosure may be disposed, is illustrated. Processing system 100 may comprise processor 102, which may be a central processing unit (CPU) or any processor core in general. Processor 102 may be configured to execute programs, software, etc., which may include load instructions in accordance with examples which will be discussed in the following sections. Processor 102 may be coupled to one or more caches, of which cache 108, is representatively shown. Cache 108 may be a data cache in one example (in some cases, cache 108 may be an instruction cache, or a combination of an instruction cache and a data cache). Cache 108, as well as one or more backing caches which may be present (but not explicitly shown) may be in communication with a main memory such as memory 110. Memory 110 may comprise physical memory including data blocks which may be brought into cache 108 for quick access by processor 102. Although cache 108 and memory 110 may be shared amongst one or more other processors or processing elements, these have not been illustrated, for the sake of simplicity.

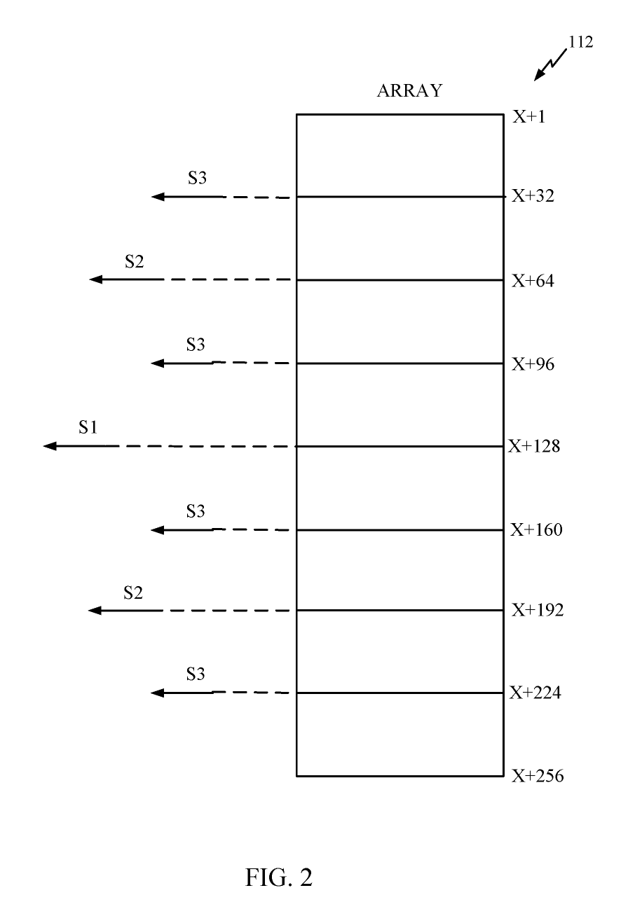

In order to reduce the penalty or latency associated with a miss in cache 108, processor 102 may include prefetch engine 104 configured to determine which data blocks are likely to be targeted by future accesses of cache 108 by processor 102 and to speculatively prefetch those data blocks into cache 108 from memory 110 in one example. In this regard, prefetch engine 104 may employ stride detection block 106 which may, in addition to (or instead of) traditional equal magnitude stride value detection, be configured to detect non-equal magnitude stride values according to exemplary aspects of this disclosure. In one example, stride detection block 106 may be configured to detect stride values which have a logarithmic relationship (or viewed differently, an exponential relationship) between successive stride values. An example of a logarithmic relationship between successive stride values is described below for a binary search operation of array 112 included in memory 110 with reference to FIG. 2.

In FIG. 2, array 112 is shown in greater detail. Array 112 may be an array of 256 data blocks, for example, which may be stored at memory locations indicated as X+1 to X+256 (wherein X is a base address or starting address, starting from which the 256 data blocks, each of 1 byte size, may be stored in memory 110). The data blocks in array 112 are assumed to be sorted by value, e.g., in ascending order, starting with the data block at address X+1 having the smallest value and the data block at address X+256 having the largest value in array 112.

In an example program implemented by processor 102, a binary search through array 112 may be involved for locating a target value within array 112. A binary search may be involved in known search algorithms to find the location of the closest match to a target or search value among a known data set. The binary search through array 112 to determine a target value among the 256 bytes may be implemented by the following step-wise process.

Starting with step S1, processor 102 may issue a load instruction to retrieve the data block in the “middle” of array 112 (i.e., located at address X+128 in this example). In practice, this may involve making a load request to cache 108, and assuming that the load request results in a miss, retrieving the value from memory 110 (a lengthy process). Subsequently, once processor 102 receives the data block at address X+128, an execution unit (not shown) of processor 102 compares the value of the data block at address X+128 to the target value. If the target value matches the data block at address X+128, then the search process is complete. Otherwise, the search proceeds to step S2.

In Step S2, two options are possible. If the target value is less than the value of data block at address X+128, the load and compare process outlined above is implemented for the data block in a “next middle”, i.e., the middle of the lower half of array 112 (i.e., the data block at address X+64). If the target value is greater than the value of data block at address X+128, then the load and compare process outlined above is implemented for the data block in another “next middle”, i.e., the middle of the upper half of array 112 (i.e., the data block at address X+192). Based on the outcome of the comparison at Step S2, the search is either complete (if a match is found at one of the data blocks at address X+64 or X+192), or the search proceeds to Step S3.

Step S3 involves repeating the above process by moving to one of the “next middles” in one of the four quadrants of array 112. The quadrant is determined based on a direction of the comparison at Step S2, i.e., the search and compare is performed with either the data blocks at addresses X+32/X+160 if the target value was less than the values of the data blocks at addresses X+64/X+192 respectively; or with either of the data blocks at addresses X+96/X+224 if the target value was greater than the values of the data blocks at addresses X+64/X+192, respectively.

In each of the above steps S1-S3, data blocks are effectively loaded from target addresses described above from memory 110, eventually to processor 102 after potentially missing in cache 108. As can be observed from at least steps S1-S3, the binary search algorithm embodies a stride value at each step that is “half” the stride value of an immediately prior step. In other words, the magnitude of each stride value is seen to have a logarithmic function (specifically, with a binary base, expressed as “log₂”) with the previous stride value (or in other words, successive stride values have a logarithmic relationship when viewed from one stride value to the following, or an exponential relationship if viewed in reverse from the perspective of one stride value to its preceding stride value). In an exemplary aspect, stride detection block 106 is configured to detect the stride value as the stated logarithmic function by observing the successive load requests made by processor 102 in steps S1-S3.

For example, in step S2, an example first stride is recognized as having magnitude 64 (either positive or negative, as the difference between the first access to address X+128 and the second access to either address X+64 or to address X+192). In step S3, the next or second stride is recognized as having magnitude 32 (again either positive or negative, as the difference between the second and third accesses to one of the pairs of addresses X+64/X+32, X+64/X+96, X+192/X+160, or X+192/X+224). Stride detection block 106 may similarly continue to detect one or more subsequent strides, in subsequent steps i.e., stride values of magnitudes 16, 8, 4, 2, 1 (or until the binary search process completes due to having found a match).

In an exemplary aspect, once a threshold number of stride values have been observed (which could be as low as two subsequent stride values, i.e., 64 and 32 to detect a logarithmic relationship between them), stride detection block 106 may influence prefetch engine 104 to prefetch data blocks anticipated for subsequent load instructions (i.e., for subsequent steps) from addresses based on the detected non-equal magnitude stride values, i.e., logarithmically-decreasing stride values. In some aspects, reaching this threshold number of stride values may be considered to be part of a training phase wherein stride detection block 106 learns the functional relationship between successive stride values and determines that this functional relationship is a logarithmic relationship for the above-described example. If in the training phase, it is confirmed that the learned functional relationship indeed corresponds to an expected non-equal magnitude stride value, the training phase may be exited and prefetch engine 104 may proceed to use the expected non-equal magnitude stride values in subsequent prefetch operations.

Although prefetch engine 104 and stride detection blocks 106 are shown as blocks in processor 102, this is merely for the sake of illustration. The exemplary functionality may be implemented by a stride magnitude comparator provisioned elsewhere within processing system 100 (e.g., functionally coupled to cache 108) to detect and recognize a sequence of load instructions exhibiting a functional relationship for non-equal magnitude strides, such as a logarithmically-decreasing stride magnitude pattern for a binary search, and influence (e.g., control) a data prefetch mechanism to generate data prefetches to anticipated subsequent iterations of the detected non-equal magnitude stride. In this manner, the latency for subsequent load instructions directed to data blocks from the prefetched addresses will be substantially reduced since these data blocks are likely to be found in cache 108 and do not have to be serviced as a miss in cache 108 to be fetched from memory 110.

As previously explained, other functional relationships for non-equal magnitude strides are also possible, such as an increasing-logarithmic (or exponential) relationship, a geometric relationship, a decreasing-fractional relationship or increasing-multiple relationship between successive stride values, etc.

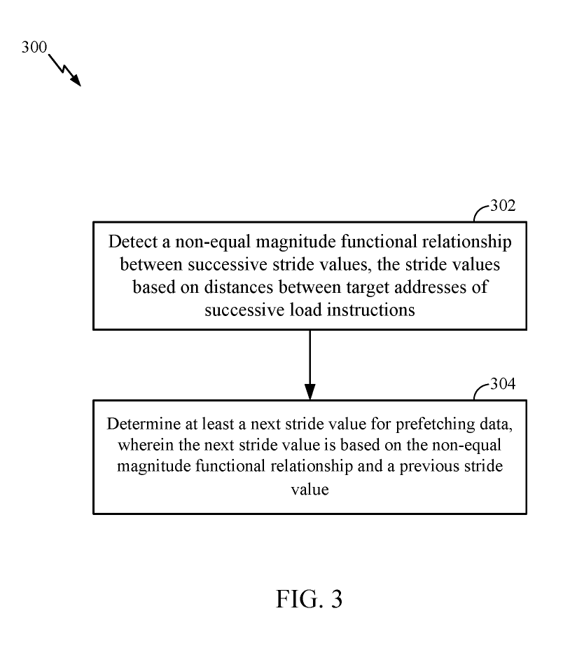

Accordingly, it will be appreciated that exemplary aspects include various methods for performing the processes, functions and/or algorithms disclosed herein. For example, FIG. 3 illustrates a prefetch method 300, e.g., implemented in processing system 100.

For example, as shown in Block 302, method 300 comprises detecting a non-equal magnitude functional relationship between successive stride values, the stride values based on distances between target addresses of successive load instructions (e.g., detecting, by stride detection block 106, a decreasing logarithmic relationship between successive load instructions in steps S1-S3 of the binary search of array 112 illustrated in FIG. 2).

In Block 304, method 300 comprises determining at least a next stride value for prefetching data, wherein the next stride value is based on the non-equal magnitude functional relationship and a previous stride value (e.g., determining, by prefetch engine 104, from the first and second strides in steps S2 and S3, stride values of 64 and 32, respectively; and in a subsequent step, determining a next stride value of 16 based on the previous stride value of 32).

In further aspects, method 300 may involve prefetching data from at least one prefetch address calculated based on the next stride value and a previous target address (e.g., prefetching data for the subsequent steps of FIG. 2 from memory 110 into cache 108 by prefetch engine 104).

As previously discussed, the non-equal magnitude functional relationship can comprise a logarithmic function, wherein the logarithmic function corresponds to successive stride values between successive load instructions of a binary search algorithm for locating a target value in an ordered array of data values stored in a memory (e.g., array 112 of memory 110). The method may include prefetching the data from a main memory (e.g., memory 110) into a cache (e.g., cache 108), in some aspects, wherein the successive load instructions are executed by a processor (e.g., processor 102) in communication with the cache. In some other cases, the non-equal magnitude functional relationship can also include different non-equal magnitude functions such as an exponential relationship, a geometric relationship, a multiple relationship, or a fractional relationship.

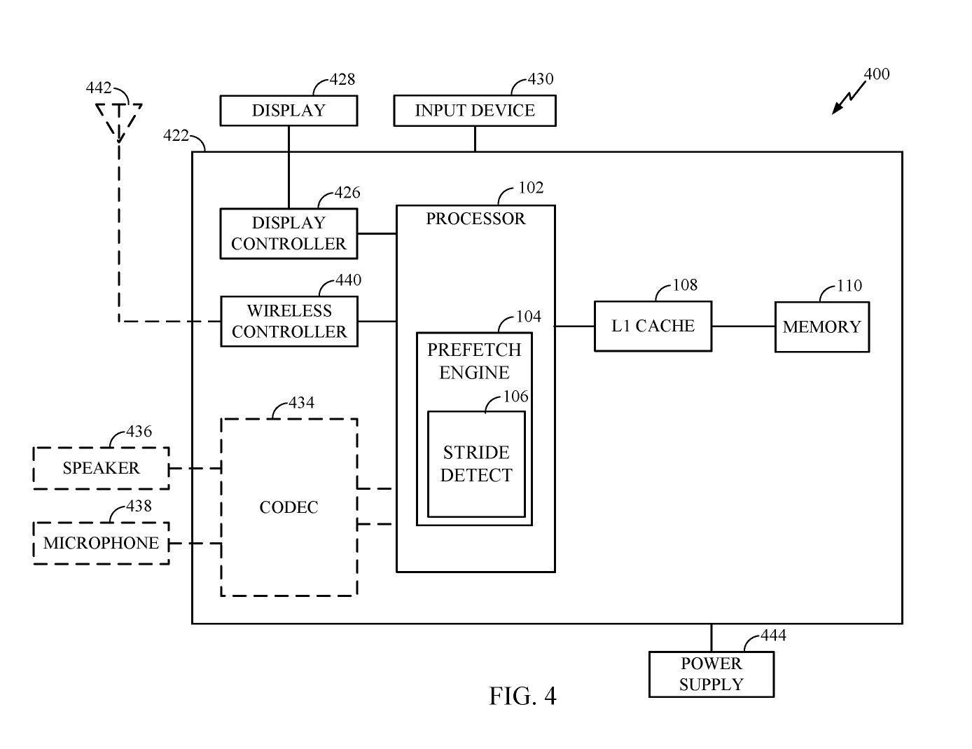

An example apparatus in which exemplary aspects of this disclosure may be utilized, will now be discussed in relation to FIG. 4. FIG. 4 shows a block diagram of computing device 400. Computing device 400 may correspond to an implementation of processing system 100 shown in FIG. 1 and configured to perform method 300 of FIG. 3. In the depiction of FIG. 4, computing device 400 is shown to include processor 102 comprising prefetch engine 104 and stride detection block 106 (which may be configured as discussed with reference to FIG. 1), cache 108, and memory 110. It will be understood that other memory configurations known in the art may also be supported by computing device 400.

FIG. 4 also shows display controller 426 that is coupled to processor 102 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 102 and speaker 436 and microphone 438 can be coupled to CODEC 434; and wireless antenna 442 coupled to wireless controller 440 which is coupled to processor 102. Where one or more of these optional blocks are present, in a particular aspect, processor 102, display controller 426, memory 110, and wireless controller 440 are included in a system-in-package or system-on-chip device 422.

Accordingly, a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 generally depicts a computing device, processor 102 and memory 110 may also be integrated into a set top box, a music player, a video player, an entertainment unit, a navigation device, a personal digital assistant (PDA), a fixed location data unit, a server, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for prefetching based on non-equal magnitude stride values. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of prefetching data, the method comprising:
detecting a non-equal magnitude functional relationship between successive stride values, the stride values based on distances between target addresses of successive load instructions; and
determining at least a next stride value for prefetching data, wherein the next stride value is based on the non-equal magnitude functional relationship and a previous stride value.

2. The method of claim 1, further comprising:
prefetching data from at least one prefetch address calculated based on the next stride value and a previous target address.

3. The method of claim 1, wherein the non-equal magnitude functional relationship comprises a logarithmic function.

4. The method of claim 3, wherein the logarithmic function corresponds to successive stride values between successive load instructions of a binary search algorithm for locating a target value in an ordered array of data values stored in a memory.

5. The method of claim 4, comprising prefetching the data from a main memory into a cache, wherein the successive load instructions are executed by a processor in communication with the cache.

6. The method of claim 1, wherein the non-equal magnitude functional relationship comprises one of an exponential relationship, a multiple relationship, a fractional relationship, or a geometric relationship.

7. An apparatus comprising:
a stride detection block configured to detect a non-equal magnitude functional relationship between successive stride values, the stride values based on distances between target addresses of successive load instructions executed by a processor; and
a prefetch engine configured to determine at least a next stride value for prefetching data, wherein the next stride value is based on the non-equal magnitude functional relationship and a previous stride value.

8. The apparatus of claim 7, wherein the prefetch engine is further configured to prefetch data from at least one prefetch address calculated based on the next stride value and a previous target address.

9. The apparatus of claim 7, wherein the non-equal magnitude functional relationship comprises a logarithmic function.

10. The apparatus of claim 9, further comprising a memory in communication with the processor, wherein the logarithmic function corresponds to successive stride values between successive load instructions of a binary search algorithm for locating a target value in an ordered array of data values stored in the memory.

11. The apparatus of claim 10, further comprising a cache, wherein the prefetch engine is configured to prefetch the data from a main memory into the cache.

12. The apparatus of claim 7, wherein the non-equal magnitude functional relationship comprises one of an exponential relationship, a multiple relationship, a fractional relationship, or a geometric relationship.

13. The apparatus of claim 7 integrated into a device selected from the group consisting of a set top box, a music player, a video player, an entertainment unit, a navigation device, a personal digital assistant (PDA), a fixed location data unit, a server, a computer, a laptop, a tablet, a communications device, and a mobile phone.

14. An apparatus comprising:
means for detecting a non-equal magnitude functional relationship between successive stride values, the stride values based on distances between target addresses of successive load instructions; and
means for determining at least a next stride value for prefetching data, wherein the next stride value is based on the non-equal magnitude functional relationship and a previous stride value.

15. The apparatus of claim 14, further comprising:
means for prefetching data from at least one prefetch address calculated based on the next stride value and a previous target address.

16. The apparatus of claim 14, wherein the non-equal magnitude functional relationship comprises a logarithmic function.

17. The apparatus of claim 16, wherein the logarithmic function corresponds to successive stride values between successive load instructions of a binary search algorithm for locating a target value in an ordered array of data values stored in a memory.

18. The apparatus of claim 17, wherein the non-equal magnitude functional relationship comprises one of an exponential relationship, a multiple relationship, a fractional relationship, or a geometric relationship.

19. A non-transitory computer readable medium comprising code, which, when executed by a processor, causes the processor to perform operations for prefetching data, the non-transitory computer readable medium comprising:
code for detecting a non-equal magnitude functional relationship between successive stride values, the stride values based on distances between target addresses of successive load instructions; and
code for determining at least a next stride value for prefetching data, wherein the next stride value is based on the non-equal magnitude functional relationship and a previous stride value.

20. The non-transitory computer readable medium of claim 19, further comprising:
code for prefetching data from at least one prefetch address calculated based on the next stride value and a previous target address.

21. The non-transitory computer readable medium of claim 19, wherein the non-equal magnitude functional relationship comprises a logarithmic function.

22. The non-transitory computer readable medium of claim 21, wherein the logarithmic function corresponds to successive stride values between successive load instructions of a binary search algorithm for locating a target value in an ordered array of data values stored in a memory.

23. The non-transitory computer readable medium of claim 19, wherein the non-equal magnitude functional relationship comprises one of an exponential relationship, a multiple relationship, a fractional relationship, or a geometric relationship.
